(19) United States
(12) Patent Application Publication
(10) Pub. No.: US 2004/0265694 A1
(43) Pub. Date: Dec. 30, 2004

(54) Fuel cell electrode

(76) Inventor: Edward Milton McWhorter, Citrus Heights, CA (US)

Correspondence Address: EDWARD M. McWHORTER, 6931 GREEN BROOK CIRCLE, CITRUS HEIGHTS, CA, 95621, US

(21) Appl. No.: 10/607,245

(22) Filed: Jun. 27, 2003

(51) Int. Cl. H01M 4/40; H01M 4/66

(52) U.S. Cl. 429/231.9; 429/245; 429/68

(57) ABSTRACT

An extruded wire of sodium metal is cold rolled into a thin foil and passed through a misting chamber coating both surfaces with a depolarizing agent and subsequently encased in an aluminized polymer membrane forming a consumable electrode for second generation fuel cells. In an alternate method of construction a polymer bead chain is attached at one edge of the electrode to facilitate its travel through the chemically reacting electrolyte.

### CROSS REFERENCES

The present invention relates to my copending application Ser. No. 10/072,166 filed Feb. 11, 2002 and Ser. No. 10/392,608 filed Mar. 21, 2003.

### BACKGROUND OF THE INVENTION

The invention is a consumable electrode for use in a fuel cell of the general character of those described in the cross-references. In these designs a cathode electrode is designed as a tape structure confining between its outer top and bottom membranes, respectively referred to as the carrier insulation and the conductor tape, the active ingredient of alkali metals, alkaline earth metals and wicking material. The present invention is a method of construction which enhances the manufacture and electrical generating capability of this type of electrode.

In the previous design of Ref. 1 a sodium dispersion in a neutral medium was applied to a lower carrier insulation tape and a conductor tape placed on top and both tapes were sealed at their contacting edges hermetically sealing the chemically reactive reagents within preventing their oxidation. In the present invention the carrier insulation tape and the conductor tape are manufactured as a single aluminized tape in which a continuous sheet of sodium metal foil is laid down and positioned on the left half of the tape and the right half of the tape is then folded over it and the two edges are hermetically sealed. In some instances the sodium sheet may be laid down upon the carrier insulation in short segments and sealed at their ends to prevent blow-back of hydrogen gases into the unreacted part of the tape as is shown in the Cross-References.

Sodium has a very low melting point and is very malleable at room temperature and can be cold rolled into thin foil sheets from its extruded wire. Knowing the extruded wire diameter and the metal foil thickness permits a more accurate accounting of sodium per inch of tape width and length. Sodium is also quite reactive and is easily oxidized in contact with the air and therefore must be processed in an inert environment. To prevent oxidation during its formation and during its processing in the electrode tape construction, a depolarizing agent is applied to the sodium metal foil surface to lower its incidental contact with air during electrode assembly and reduce the effect of air diffusion through the aluminized carrier insulation and thereby increase its useful shelf-life.

In the previous consumable electrode designs presented in the Cross-References a separate means was employed for passing the electrode into the electrolyte. In the present invention a bead-chain is inserted between the edges of the folded tape during the sealing process and sealed in place between the two edges. The bead-chain, pulled by bead-gears will assist the passage of the electrode through the electrolyte preventing tensile failure of the electrode tape during the high exothermic reaction of the sodium foil with the water in the electrolyte.

### SUMMARY OF THE INVENTION

A consumable electrode containing a sodium foil is constructed from a single piece of aluminized tape which is folded at its center and its edges are brought together and sealed hermetically encompassing the sodium foil. In an alternate design a bead-chain is inserted in the edges of the folded aluminized tape containing the sodium foil.

It is an object of the invention to simplify the construction of a consumable electrode from a single tape.

It is another object of the invention to apply the sodium initiator of a consumable electrode as a metal foil such that its content is more evenly distributed per linear length of the tape electrode.

It is yet another object of the invention to provide a means of carrying a consumable electrode through a chemically reacting electrolyte by the addition of a bead-chain interposed between the sealing edges of the electrode such that it is fixedly sealed with the tape.

### DRAWINGS OF THE INVENTION

Drawings of the invention are presented as a part of the specification.

FIG. 1 shows a length of aluminized tape holding near one edge a length of sodium foil.

FIG. 2 shows the length of aluminized tape of FIG. 1 folded at its center and its edges brought together and sealed at its edges.

FIG. 3 is a drawing of a beaded-chain of the general type to be described.

FIG. 4 is a drawing of a bead-chain inserted and sealed between the edges of the consumable electrode.

FIG. 5 is a drawing of the consumable electrode being carried through the electrolyte by the bead-chain gearing.

### DETAILED DESCRIPTION OF THE INVENTION

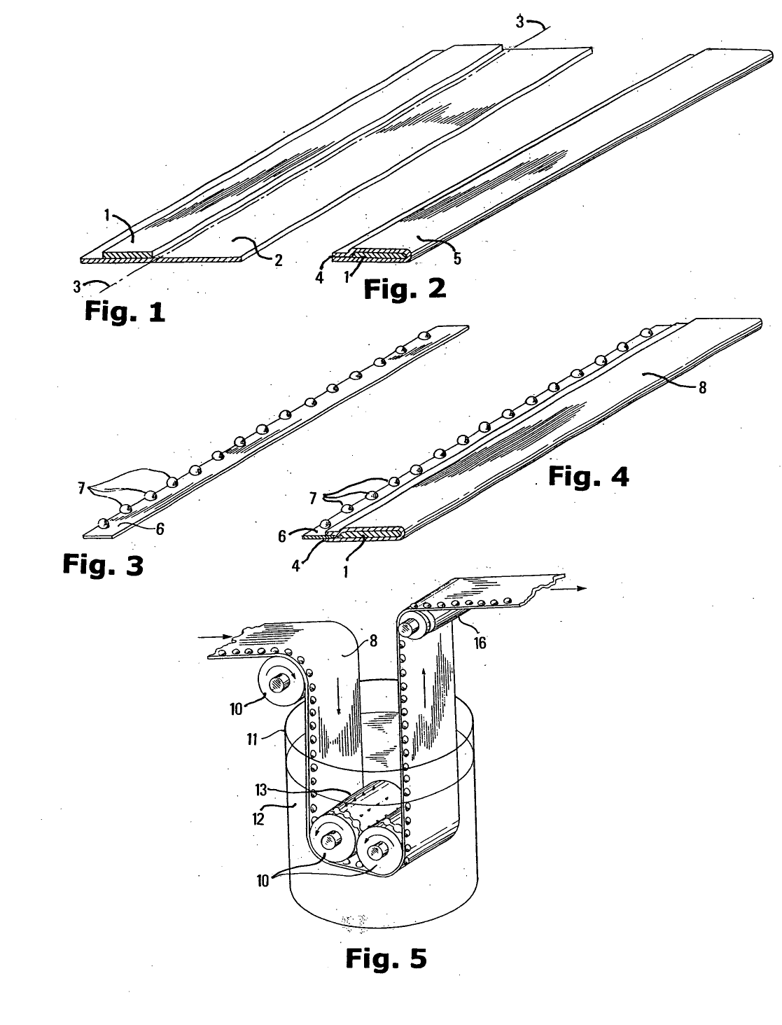

Sodium metal is extruded as a wire which is subsequently cold rolled into continuous sheets of thin foil 1 which is passed through a agent. In FIG. 1 a segment of foil 1 is positioned at one edge of an aluminized polymer tape hereinafter called the carrier tape 2. Said carrier tape 2 is folded along its longitudinal center-line 3 and its two edges brought together at point 4 and sealed along the entire length of the carrier tape 2, hermetically sealing and encasing sodium foil 1 within as shown in FIG. 2 forming consumable electrode 5 which is subsequently rolled upon a spool.

Turning now to FIG. 3 which is a drawing of a polymer bead-chain 6 comprising a column of polymer spheres 7 formed at regularly spaced intervals upon its surface. Bead-chain 6 is inserted between the two edges of folded aluminized tape 2 at point 4 and sealed in place with both edges of polymer tape 2 forming consumable electrode 8 as shown in FIG. 4. Those skilled in the art will readily perceive that polymer tape 2 and polymer bead chain 6 can be manufactured as a single membrane comprising the column of spheres 7 spaced at regular distances along one edge.

FIG. 5 shows the manner in which consumable electrode 8 is carried downward by bead-gear 10 into vat 11 holding the cell electrolyte 12 and passes under pin roller 13 driven by another bead-gear 10 and under still another bead gear roller 10 and upward to guide roller 16 and passes out of the cell electrolyte as expended tape.

### Numbered Elements of the Drawings

1. Sodium foil

2. Polymer tape

3. Centerline

4. Sealing point

5. Electrode

6. Bead-chain

7, Spheres

8. electrode

9.

10. Bead-gear (3 places)

11. Vat

12. Electrolyte

13. Pin roller

14.

15.

16. Guide roller

What is claimed is:

1. A consumable electrode comprising a segment of sodium foil, said sodium foil being inset from one edge and longitudinally positioned lengthwise along one half of an aluminized polymer tape, said aluminized polymer tape being folded at its longitudinal center and both halves of said aluminized polymer tape brought together and sealed at their contacting edges hermetically sealing and encasing the said sodium foil within.

2. The consumable electrode of claim 1 in which the said sodium foil is coated on both sides with a depolarizing agent.

3. The consumable electrode of claim 1 in which the said sodium foil is segmented at regular intervals.

4. The consumable electrode of claim 1 incorporating a bead-chain at one edge to facilitate its insertion into an electrolyte vat.
